(19) United States
(12) Patent Application Publication
(10) Pub. No.: US 2011/0045777 A1
(43) Pub. Date: Feb. 24, 2011

(54) WIRELESS MONITORING SYSTEM CAPABLE OF ENSURING RELATIVELY LOW RADIATION TO AN OBJECT TO BE MONITORED

(76) Inventor: Ji-Hong Hsiao, Taipei County (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 12/544,380

(22) Filed: Aug. 20, 2009

(51) Int. Cl. H04B 7/005

(52) U.S. Cl. 455/66.1

(57) ABSTRACT

A wireless monitoring system includes a first terminal wirelessly transmitting an output associated with a monitored object to a second terminal. The first terminal includes an antenna unit including an antenna array of a number (N) of directional antennas each radiating a relatively high power density in a specific angular direction, where N≧2, and a switch unit having a number (N) of switches each coupled between a corresponding directional antenna and a transceiving unit. When the object is located in the angular direction of one directional antenna, at least one corresponding switch coupled to said one directional antenna is selectively switched to an OFF-mode and the other switches are selectively switched to an ON-mode such that the first terminal transmits the output to the second terminal through the other directional antennas, thereby ensuring relatively low radiation to the object during transmission of the first terminal.

### BACKGROUND OF THE INVENTION 1. Field of the Invention

The invention relates to a monitoring system, more particularly to a wireless monitoring system.

2. Description of the Related Art

A conventional wireless baby monitor includes a baby terminal for monitoring a baby to be monitored and wirelessly transmitting a monitored result to a caregiver terminal through an antenna. However, in such a configuration, the baby monitor is usually disposed adjacent to the baby for a superior monitoring effect such that radiation from the antenna, especially, for a long period of time during use may incur harmful influences on health of the baby. Therefore, it is desired to design a wireless person monitoring system capable of ensuring relatively low radiation to a person to be monitored.

### SUMMARY OF THE INVENTION

Therefore, an object of the present invention is to provide a wireless monitoring system that is capable of ensuring relatively low radiation to an object to be monitored.

According to the present invention, a wireless monitoring system comprises:

a first terminal adapted to be disposed adjacent to an object to be monitored so as to monitor the object, and transmitting wirelessly an output associated with the object; and

a second terminal remote from the first terminal and wirelessly communicating with the first terminal for receiving the output therefrom.

the first terminal including
a monitoring unit adapted for monitoring the object and generating a monitored result associated with the object,
a processor coupled to the monitoring unit, receiving the monitored result from the monitoring unit and outputting the output based on the monitored result received thereby,
a transceiving unit coupled to the processor for receiving the output therefrom,
an antenna unit including an antenna array of a number (N) of directional antennas each radiating a relatively high power density in a specific angular direction, where N≧2, and
a switch unit having a number (N) of switches each coupled between a corresponding one of the directional antennas and the transceiving unit and operable between an ON-mode and an OFF-mode.

When the object is located in the angular direction of one of the directional antennas, at least corresponding one of the switches coupled to said one of the directional antennas is selectively switched to the OFF-mode and the other ones of the switches are selectively switched to the ON-mode such that the transceiving unit of the first terminal transmits the output received thereby to the second terminal through the other ones of the directional antennas, thereby ensuring relatively low radiation to the object during transmission of the first terminal.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic circuit block diagram illustrating the preferred embodiment of a wireless monitoring system according to the present invention;

FIG. 2 is a perspective view showing a first terminal of the preferred embodiment;

FIG. 3 is a schematic top view showing an antenna unit of the first terminal of the preferred embodiment;

FIG. 4 is a schematic view illustrating horizontal radiation patterns of the antenna unit of the first terminal of the preferred embodiment; and

FIG. 5 illustrates the first terminal of the preferred embodiment in a state of use.

### DETAILED DESCRIPTION OF THE PREFERRED EMBODIMENT

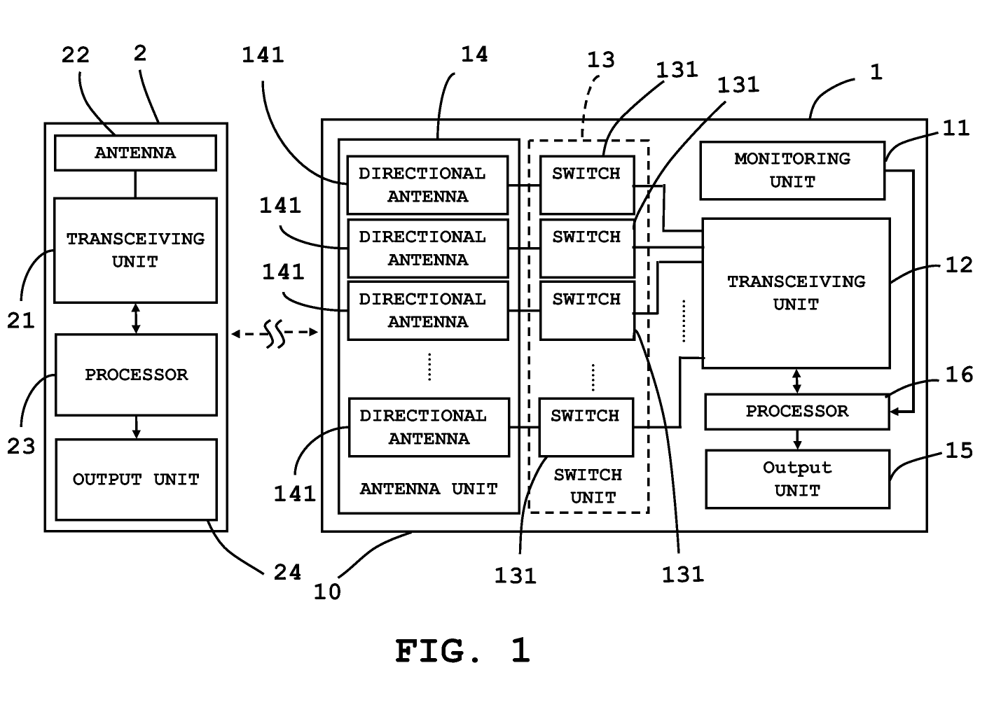

Referring to FIG. 1, the preferred embodiment of a wireless monitoring system according to the present invention is shown to include a first terminal 1 and a second terminal 2. In this embodiment, the wireless monitoring system is a person monitoring system, such as a baby monitoring system.

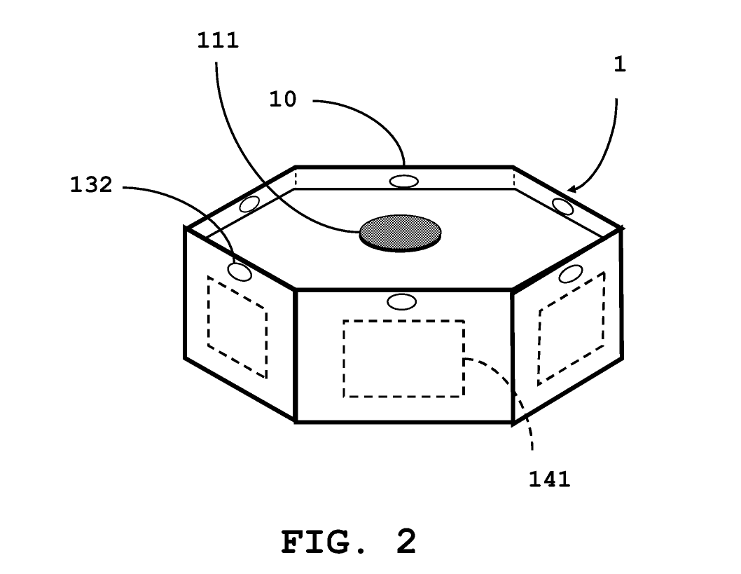

The first terminal 1, such as a baby terminal, is adapted to be disposed adjacent to a baby (not shown) that serves as an object to be monitored so as to monitor the baby, and transmits wirelessly an output associated with the baby. As shown in FIGS. 1 and 2, the first terminal 1 includes a housing 10, a monitoring unit 11, a processor 16, a transceiving unit 12, an antenna unit 14, a switch unit 13, and an output unit 15. The monitoring unit 11 is adapted for monitoring the baby and generating a monitored result associated with the baby. In this embodiment, the monitoring unit 11 includes a microphone 111 mounted on the housing 10 (see FIG. 2) for collecting sound generated by the baby and generating an audio signal corresponding to the sound generated by the baby. The audio signal serves as the monitored result.

The processor 16 is disposed in the housing 10, is coupled to the monitoring unit 11 and the output unit 15, receives the audio signal from the monitoring unit 11, and outputs the output based on the monitored result. In this embodiment, the output is audio information. In other embodiments, the output can be at least one of video information and vital information, such as temperature information, associated with the baby.

The transceiving unit 12 is disposed in the housing 10, is coupled to the processor 16, and receives the output from the processor 16. Since the feature of this invention does not reside in the configuration of the transceiving unit 12, which is known to those skilled in the art, details of the same are omitted herein for the sake of brevity.

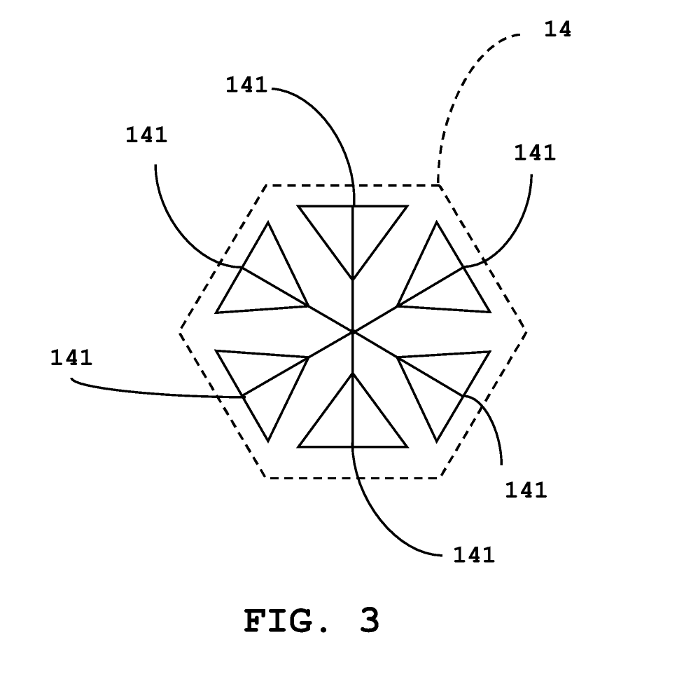

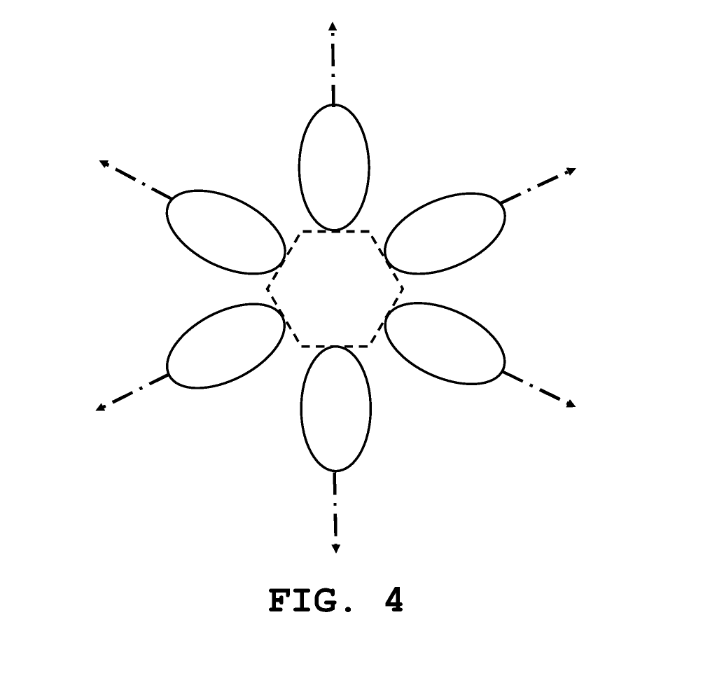

The antenna unit 14 is disposed in the housing 10, and includes an antenna array of a number (N) of directional antennas, such as sector antennas, each radiating a relatively high power density in a specific angular direction, where N>2. In this embodiment, the antenna array is in the form of a sectored antenna array, wherein N=6 and the directional antennas 141 are arranged in a regular hexagon, as shown in FIG. 3. FIG. 4 illustrates horizontal radiation patterns of the directional antennas 141, wherein the directional antennas 141 radiate a relatively high power density in difference angular directions indicated by imaginary-line arrows.

The switch unit 13 has a number (N) of switches 131 each coupled between a corresponding directional antenna 141 and the transceiving unit 12 and operable between an ON-mode and an OFF-mode. In this embodiment, each switch 131 includes an operating button 132 mounted on the housing 10, as shown in FIG. 2, and operable to switch between the ON-mode and the OFF-mode.

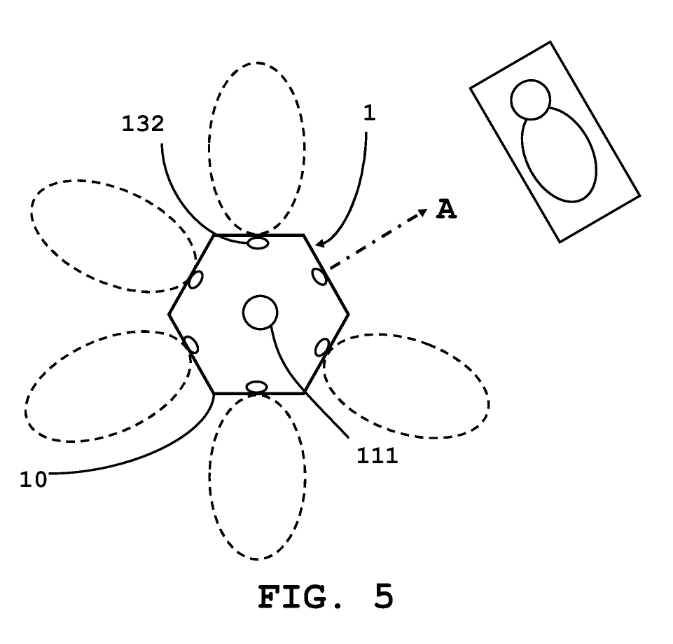

In use, as shown in FIG. 5, when a baby to be monitored is located in the angular direction of one directional antenna 141 indicated by an imaginary-line arrow (A), at least corresponding switch 131 coupled to said one directional antenna 141 is selectively switched to the OFF-mode, i.e., said one directional antenna 141 is disabled, and the other switches 131 are selectively switched to the ON-mode, i.e., the other directional antennas 141 are enabled, such that the transceiving unit 12 transmits the output received thereby to the second terminal 2 through the other directional antennas 141, thereby ensuring relatively low radiation to the baby during transmission of the first terminal 1.

The second terminal 2, such as a care-giver terminal, is remote from the first terminal 1, and wirelessly communicates with the first terminal 1 for receiving the output therefrom. In this embodiment, the second terminal 2 includes an antenna 22, a transceiver 21, a processor 23, and an output unit 24.

The transceiver 21 is coupled to the antenna 22 and the processor 23, receives the output from the first terminal 1 through the antenna 22, and outputs the output received thereby to the processor 23.

The processor 23 is coupled to the transceiver 21 and the output unit 24, receives the output from the transceiver 21, and sends the output received thereby to the output unit 24 such that the output unit 24 outputs the output. In this embodiment, the output unit 24 includes a loudspeaker for reproducing the output. In other embodiments, the output unit can be a display for displaying the output thereon. Furthermore, the processor 23 is further operable so as to generate a response output based on the output from the transceiver 21, and outputs the response output to the transceiver 21. The transceiver 21 transmits the response output received thereby to the first terminal 1 through the antenna 22. As a result, the processor 16 of the first terminal 1 receives the response output from the second terminal 2 through the enabled directional antennas 141 and the transceiving unit 12, and sends the response output received thereby to the output unit 15. Then, the output unit 15 of the first terminal 1 outputs the response output.

In this embodiment, the output unit 15 of the first terminal 1 includes a loudspeaker (not shown). In other embodiments, the output unit 15 of the first terminal 1 can be a display. For example, when the output transmitted from the first terminal 1 is presented as crying sound, the response output is presented as caregiver's sayings to pacify the crying baby.

In sum, due to the presence of the switch unit 13, the first terminal 1 is capable of appropriately selecting the directional antennas 141 to be enabled for transmission by operation of the operating buttons 132 of the switches 131. Therefore, the wireless monitoring system of the present invention can ensure relatively low radiation to the object to be monitored during use, thereby minimizing harmful influences on health of the object, especially, to a human body, as a result of high radiation for a long period of time.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A wireless monitoring system comprising:
a first terminal adapted to be disposed adjacent to an object to be monitored so as to monitor the object, and transmitting wirelessly an output associated with the object; and
a second terminal remote from said first terminal and wirelessly communicating with said first terminal for receiving the output therefrom;
said first terminal including
a monitoring unit adapted for monitoring the object and generating a monitored result associated with the object,
a processor coupled to said monitoring unit, receiving the monitored result from said monitoring unit, and outputting the output based on the monitored result received thereby,
a transceiving unit coupled to said processor for receiving the output therefrom,
an antenna unit including an antenna array of a number (N) of directional antennas each radiating a relatively high power density in a specific angular direction, where N>2, and
a switch unit having a number (N) of switches each coupled between a corresponding one of said directional antennas and said transceiving unit and operable between an ON-mode and an OFF-mode;
wherein, when the object is located in the angular direction of one of said directional antennas, at least corresponding one of said switches coupled to said one of said directional antennas is selectively switched to the OFF-mode and the other ones of said switches are selectively switched to the ON-mode such that said transceiving unit of said first terminal transmits the output received thereby to said second terminal through the other ones of said directional antennas, thereby ensuring relatively low radiation to the object during transmission of said first terminal.

2. The wireless monitoring system as claimed in claim 1, wherein the antenna array of said first terminal is in the form of a sectored antenna array.

3. The wireless monitoring system as claimed in claim 1, wherein each of said directional antennas of said first terminal is a sector antenna.

4. The wireless monitoring system as claimed in claim 1, the object being a human body, wherein the output outputted by said processor of said first terminal includes at least one of audio information, video information and vital information associated with the human body.

5. The wireless monitoring system as claimed in claim 1, wherein:
said second terminal generates a response output based on the output received thereby, and transmits the response output to said first terminal; and
said first terminal further includes an output unit coupled to said processor, said processor of said first terminal unit receiving the response output from said second terminal through the other ones of said directional antennas of said antenna unit and said transceiving unit, and sending the response output received thereby to said output unit such that said output unit outputs the response output.
